(19) United States
(12) Patent Application Publication
(10) Pub. No.: US 2016/0119267 A1
(43) Pub. Date: Apr. 28, 2016

(54) METHOD FOR NOTIFYING A SALES PERSON OF A SALES PROSPECT

(71) Applicant: Suna IP Pty LTD, Quennsland (AU)

(72) Inventors: Russell J. Taylor, Queensland (AU); Scott W. Dunlop, Queensland (AU)

(21) Appl. No.: 14/990,442

(22) Filed: Jan. 7, 2016

Related U.S. Application Data
(63) Continuation of application No. 13/576,719, filed on Oct. 22, 2012.

(30) Foreign Application Priority Data
Feb. 5, 2010 (AU) 2010900456

(51) Int. Cl. H04L 12/58; H04L 29/08

(52) U.S. Cl. CPC H04L 51/18; H04L 67/22

(57) ABSTRACT

A computer system and method that immediately alerts a sales person with a notification message when the online behavior or usage criteria of a subscriber is met, so that the sales person may follow up on the sales lead before the subscriber loses interest in the commodity or buys elsewhere. With the preferred embodiment, the activity criteria for each subscriber (or a group of subscribers) can be preset by the sales person, so as to selectively quantify degrees of activity that triggers the sending notification messages. With the preferred embodiment records are kept of all the events, including triggers and messages sent in relation to the subscribers and sales persons and these records provide valuable management information for evaluating the efficiency of online marketing campaigns.

### RELATED APPLICATIONS

This application is a continuation application of U.S. patent application Ser. No. 13/576,719 filed Oct. 22, 2012, which claims priority of International Application No. PCT/AU2011/000107 filed Feb. 3, 2011 which claims the benefit of AU Provisional Application No. 2010900456 filed on Feb. 5, 2010. The entire disclosures of these applications are hereby incorporated by reference.

### FIELD OF INVENTION

The present invention relates to electronic or online marketing. In particular, the invention relates to a computer system, a method, and a computer program product for use in online marketing.

This invention has particular application for use in email marketing campaigns for a real estate agency. It will therefore be convenient hereinafter to describe the invention with reference to this example application. However, at the same time it must be recognized that the invention applies to other applications, such as online marketing campaigns for any vendor or merchant advertised goods and services.

### BACKGROUND OF THE INVENTION

Electronic or online marketing is widely used by sales entities to promote products and services. Online marketing typically includes sending information about the sales entity and its commodities to sales prospects by way of email messages and or by way of posting information about its commodities on websites.

Email-tracking and web-tracking are techniques used to monitor the user or client behavior in relation to the usage of emails and website, so as to form a view of online user behavior. Information about online user behavior provides valuable insight to a sales entity about the efficiency of their online marketing campaigns.

In addition, tracking of an individual's online behavior in relation to marketing information of a sales entity may provide useful information to the sales entity about the interest of the user in a specific commodity that is goods or services.

Current methods include logging and analyzing the online activity of users or subscribers and then passing the analyzed information to the sales entity. The analyzed information includes some identification of the subscriber and information about the online activities of the subscriber who viewed information online about a particular commodity. The sales person can then pursue the subscriber who viewed the commodity online. However there is often a delay from processing the captured online activity information of subscribers and distributing it to the relevant sales persons. The delay can cause a failure to pursue a sales lead within a meaningful time frame. For example, a subscriber who had been identified as being interested in a particular real estate property will not be contacted by the relevant salesperson for several days during which time their interest may have waned or they may have bought a property elsewhere.

### OBJECT OF THE INVENTION

It is an object of the present invention to provide a computer system and method that reduces the time delay for a sales person to follow up on a sales lead based on online user or subscriber activities.

### SUMMARY OF THE INVENTION

The present invention was developed in part by the realization that repetitive opening or repetitive visiting by a user of an email or webpage respectively containing information about a commodity generally corresponds to the degree of interest by the user in the commodity and that information about the degree of interest shown by a user in a commodity is valuable to a sales person as it indicates a potential sales lead that can result in a sale. With this realization the inventors of the current invention developed a solution to quantify the interest shown by a potential sales lead and correlate with their contact details so that the sales lead can be pursued.

In one aspect, the invention broadly resides in a computer-implemented method for notifying a sales person of a sales prospect, the method including:
detecting with a server-side computer system, at least one activity occurring at a terminal computer that is activated for displaying or requesting information associated with the sales person;
identifying a candidate prospect that is associated with the at least one activity;
updating an activity record for the identified candidate prospect;
determining if the updated activity record for the identified candidate prospect meets predefined activity criteria for the identified candidate prospect, which activity criteria when met qualifies the identified candidate prospect as a sales prospect; and
if the activity criteria is met, triggering the sending of a notification message to the sales person.

Detecting the at least one activity occurring at a terminal computer preferably includes detecting when an electronic mail message (email) is rendered on a terminal computer for viewing information associated with the sales person in a body of the email.

Detecting when the email message is rendered for viewing on the terminal computer preferably includes the prior steps of embedding a unique hyperlink in the body of the email message and sending the email message to an email inbox of the candidate prospect, which unique hyperlink includes a unique identifier associated with the candidate prospect, and detecting when a request is received in response to when the unique hyperlink is activated when the email message is rendered for displaying on the terminal computer.

Identifying a candidate prospect that is associated with the at least one activity, in response to detecting the at least one activity, preferably includes identifying the unique identifier associated with the candidate prospect, when a request is received in response to when the unique hyperlink is activated when the email message is rendered for displaying on the terminal computer.

Updating the activity record for the identified candidate prospect preferably includes logging an email-opened event in the activity record each time when the request is received in response to when the unique hyperlink is activated when the email message is rendered for display on the terminal computer, and date stamping the email-opened event.

Determining if the updated activity record for the identified candidate prospect meets predefined activity criteria for the identified candidate prospect preferably includes determining if the number of logged email-opened events for the identified candidate prospect matches a preset value of a number of times that qualifies the identified candidate prospect as a sales prospect.

The method preferably includes the prior steps of sending user interface information to a terminal computer for rendering a user interface in a form that permits the sales person to input the preset value of the number of times that an email-opened event needs to occur to qualify a candidate prospect as a sales prospect.

Preferably, detecting the at least one activity occurring at a terminal computer includes detecting when a hyperlink is activated that links to media content of a commodity of the sales person.

Detecting when a hyperlink is activated that links to media content of a commodity of the sales person preferably includes generating a unique hyperlink that includes a unique identifier associated with the candidate prospect, and a unique commodity identifier associated with the media content of the commodity of the sales person, and detecting when a request is received in response to when the unique hyperlink to the media content of the commodity of the sales person is activated.

Identifying a candidate prospect preferably includes identifying the unique identifier associated with the candidate prospect, when a request is received in response to when the unique hyperlink to the media content of the commodity of the sales person is activated.

Updating the activity record for the identified candidate prospect preferably includes logging a link-clicked event in the activity record in relation to the identified candidate prospect each time when the unique request is received in response to when the unique hyperlink to the media content of the commodity of the sales person is activated, and date stamping the link-clicked event.

Moreover, determining if the updated activity record for the identified candidate prospect meets predefined activity criteria for the identified candidate prospect, preferably includes determining if the number of logged link-clicked events for the identified candidate prospect matches a preset value of the number of times that a same request is receive in response to when a same unique hyperlink to the media content of the same commodity of the sales person is activated.

The method preferably includes the prior step of sending user interface information to a terminal computer for rendering a user interface in a form that permits the sales person to input the preset value of the number of times that a same hyperlink needs to be activated that qualifies a candidate prospect as a sales prospect.

Determining if the updated activity record for the identified candidate prospect meets predefined activity criteria for the identified candidate prospect, preferably includes determining if the number of logged link-clicked events for the identified candidate prospect matches a preset value of the number of times that any request is received in response to when any unique hyperlink to any of the media content of the commodities of the sales person is activated.

The method preferably includes sending user interface information to a terminal computer for rendering a user interface in a form that permits the sales person to input the preset value of the number of times any unique hyperlink to any of the media content of the commodity of the sales person needs to be activated that qualifies a candidate prospect as a sales prospect.

Triggering the sending of a notification message to the sales person, if the activity criteria are met, preferably includes triggering the sending of a notification message to an electronic message delivery system for retrieval by the sales person with a terminal computer.

Triggering the sending of a notification message to an electronic message delivery system preferably includes triggering the sending of a text message for sending by way of the Short Message Service (SMS) to text message delivery system for retrieval by the sales person with mobile telephonic device.

Triggering the sending of a notification message to the sales person preferably includes triggering sending of an email message to an email message delivery system for retrieval by the sales person with a terminal computer.

The method preferably includes logging a notification message-sent trigger event in a message-sent record in relation to the candidate prospect and the sales person, when sending of the notification message is triggered, and date stamping the notification message-trigger event.

The method preferably includes determining from the message-sent record if a notification message is already sent to the sales person prior to triggering the sending of the notification message, so as to avoid duplicate sending of a same notification message.

To this end, the method preferably includes triggering sending of the notification message to the sales person and to at least one other person. The method preferably includes triggering sending of an email message or an SMS message to the at least one other person.

The method preferably includes logging a notification message-trigger event in the message-sent record in relation to the at least one other person, when the notification message is sent, and date stamping the notification message-trigger event.

The method preferably includes compiling a notification message, prior to sending the notification message. Compiling the notification message preferably includes retrieving message content from a database.

Retrieving message content from the database preferably includes the prior step of configuring the database with notification message content by the sales person, which notification message content preferably includes any content selected from at least identification information of the identified sales prospect and identification information of a commodity in relation to which the hyperlink is activated by the identified sales prospect.

The method preferably includes triggering sending of a first response message to the sales candidate, if the activity criteria are met.

In addition, triggering sending of a first response message to the sales candidate preferably includes triggering sending of a text message to the sales candidate by way of the Short Message Service (SMS).

Triggering sending of a first response message to the sales candidate preferably includes sending an email message to the sales candidate.

The method preferably includes logging a first response message-trigger event in the message-sent record in relation to the sales candidate, when the first response message is triggered for sending, and date stamping the first response message-trigger event.

The method preferably includes the prior step of compiling a first response message that includes information selected from: an explanation for receiving the first response message, information about the sales person, questions for obtaining further information from the identified sales prospect for further qualifying the identified sales prospect.

The method preferably includes the prior step of sending user interface information to a terminal computer for rending a graphical user interface in a form that permits input of information from a sales person to configure the computer system.

The method preferably includes sending user interface information to a terminal computer for rending a graphical user interface in a form that permits input of information by the sales person in the database that relates to: information about commodities, information about at least one sales person in relation to the commodities, information about candidate prospects, content for the notification message, and content for the first response message, and the like.

Preferably, the method includes sending user interface information to a terminal computer for rendering a graphical user interface in a form that permits input of information to configure the computer system with activity criteria for each candidate prospect individually or for a group of candidate prospects.

The method preferably further includes sending presentation information to a terminal computer for rendering a graphical user interface, in response to receiving an associated request that includes reporting information extracted from the updated records of the computer system for presenting a report to the sales person.

In a second aspect, the invention broadly resides in a computer program product having stored thereon computer executable instructions, which when executed, causes the computer to perform the method as defined above.

In a third aspect, the invention broadly resides in a web-based computer program product having stored thereon computer executable instructions, which when executed on a web-based computer system causes the web-based computer system to perform the method as defined above.

In a fourth aspect the invention broadly resides in a computer system for notifying a sales person of a sales prospect, the computer system including:
a processor, memory interfaced with the processor, and a network interface for establishing a network connection over a data communication network with a terminal computer;
a module for detecting at least one activity occurring at a terminal computer that is activated for displaying or requesting information associated with the sales person,
a module for identifying a candidate prospect that is associated with the at least one activity, in response to detecting the at least one activity;
a module for updating an activity record for the identified candidate prospect;
a module for determining if the updated activity record for the identified candidate prospect meets predefined activity criteria for the identified candidate prospect, which activity criteria when met qualifies the identified candidate prospect as a sales prospect; and
a module for triggering sending of a notification message to the sales person if the activity criteria is met.

The computer system preferably includes a plurality of further modules that are configured for performing any one or more of the method steps as herein defined, described and illustrated.

In a fifth aspect, the invention broadly resides in a method for notifying a sales person of a sales prospect, which method includes:
having a web-based program that interfaces with a database including information regarding at least one candidate prospect, at least one commodity and at least one sales person associated with the at least one commodity, said web-based program being configured with predetermined web activity criteria so that when the web activity of the candidate prospect meets the predetermined web activity criteria then the candidate prospect forms a sales prospect and when a sales prospect is formed the web based program sends a message,
logging web activity of the candidate prospect;
determining if the logged web activity of the candidate prospect meets the web activity criteria; and
sending a message to the one or more sales persons if the web activity criteria is met.

### BRIEF DESCRIPTION OF THE DRAWINGS

In order that the present invention can be more readily understood reference will now be made to the accompanying diagrammatic drawings which illustrate a preferred embodiment of the invention and wherein:

FIG. 1 is a schematic drawing of a computer network that includes a computer system, in accordance with the invention;

FIG. 2 is a functional flow diagram of a method, in accordance with the invention, for notifying a sales person of a sales prospect using the computer system in FIG. 1;

FIG. 3 is a first user interface, rendered for display on a terminal computer, for configuring the computer system in FIG. 1;

FIG. 4 is a second user interface, rendered for display on a terminal computer, for configuring the computer system in FIG. 1;

FIG. 5 is a third user interface, rendered for display on a terminal computer, for configuring the computer system in FIG. 1;

FIG. 6 is a forth user interface, rendered for display on a terminal computer, for configuring the computer system in FIG. 1;

FIG. 7 is a fifth user interface, rendered for display on a terminal computer, for configuring the computer system in FIG. 1;

FIG. 8 is a sixth user interface, rendered for display on a terminal computer, for configuring the computer system in FIG. 1;

FIG. 9 is a functional flow diagram of part of a script executed on the computer system to perform the method in FIG. 2;

FIG. 10 is a functional flow diagram showing another part of the method;

FIG. 11 is a functional flow diagram showing a yet another part of the method; and

FIG. 12 is a functional flow diagram showing a further part of the method.

### DETAILED DESCRIPTION OF THE PREFERRED EMBODIMENT

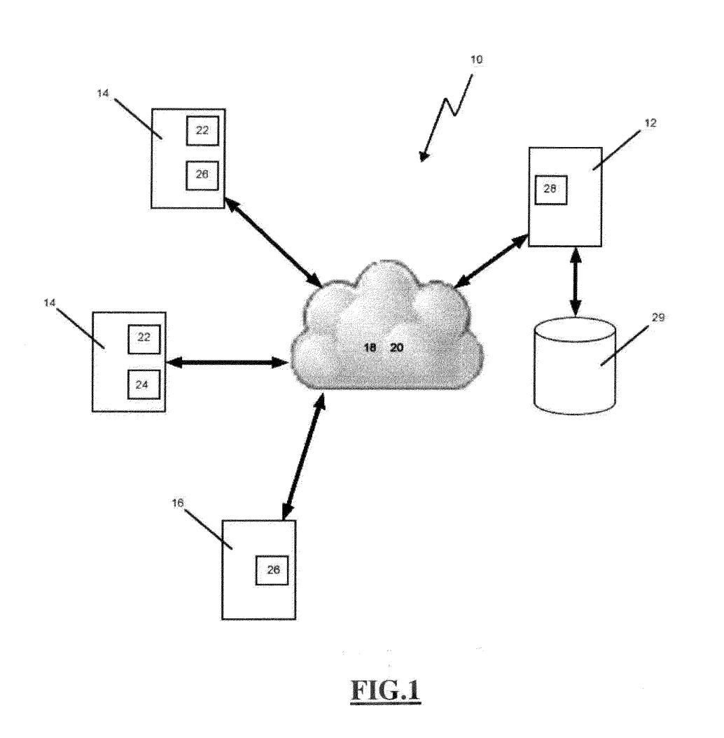

In FIG. 1, reference numeral 10 refers generally to a computer network in the form of a client-server computer network. The computer network 10 includes a server-side computer system 12, in accordance with the invention, for notifying a sales person of a sales prospect (sales lead), and a plurality of terminal computers 14, 16 that are connected in data communication over the data communication network to the server-side computer system 12.

The terminal computers 14, 16 can be in the form of any computing device for communicating over the data communication network. Thus, the terminal computer 14, 16 can be a personal computer 14 having a network interface for connecting over the Internet 18 to the server-side computer system 12. The terminal computer can also be a mobile terminal 16, such as mobile telephonic device, for connecting over a telecommunication network 20.

In particular, the server-side computer system 12 in this embodiment is a server side web-based computer system. The computer system 12 includes a plurality of web modules or components 28 that are deployed in web containers on the server system 12 and that are executable on the computer system 12 to perform computer implemented steps, in accordance with the method of the invention for notifying a sales person of a sales prospect, as is explained in more detail below. The web-based computer system 12 also includes a database 30 in the form of an object-relational database 29 for storing information. It will be appreciated that the computer system 12 and the database 30 can be a distributed web-based computer system.

The web modules are invoked by client modules such as a thin-client module in the form of a web browser and email message viewer 24 on the personal computers (PCs) 14, and SMS message (text message) viewers 26 on the mobile telephone devices 16

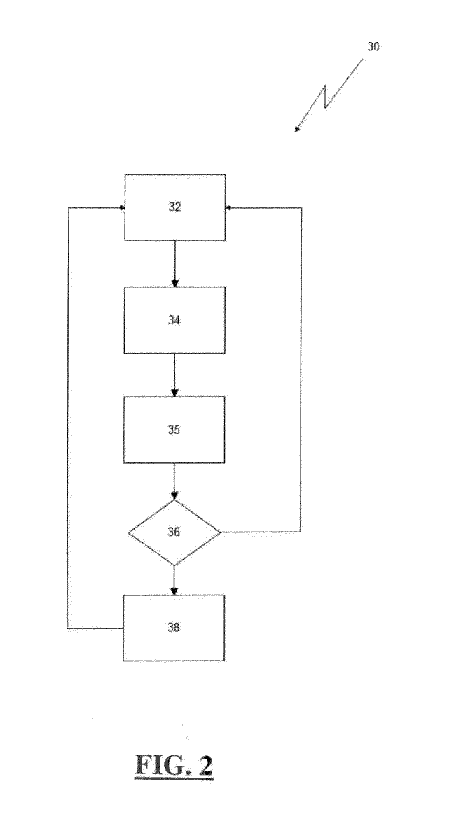

Referring to FIG. 2, broadly, the method 30 includes, with the web-based computer system 12, detecting, at 32, at least one activity occurring at a terminal computer that is activated for displaying or requesting information associated with the sales person.

The method further includes identifying, at 34, a candidate prospect that is associated with the at least one activity, in response to detecting the at least one activity, and updating, at 35, an activity record for the identified candidate prospect.

At 36, the method includes determining, with the computer system 12, if the updated activity record for the identified candidate prospect meets predefined activity criteria for the identified candidate prospect. The activity criteria when met qualify the identified candidate prospect as a sales prospect.

If the activity criteria are met, then the method includes sending, at 38, a notification message to the sales person.

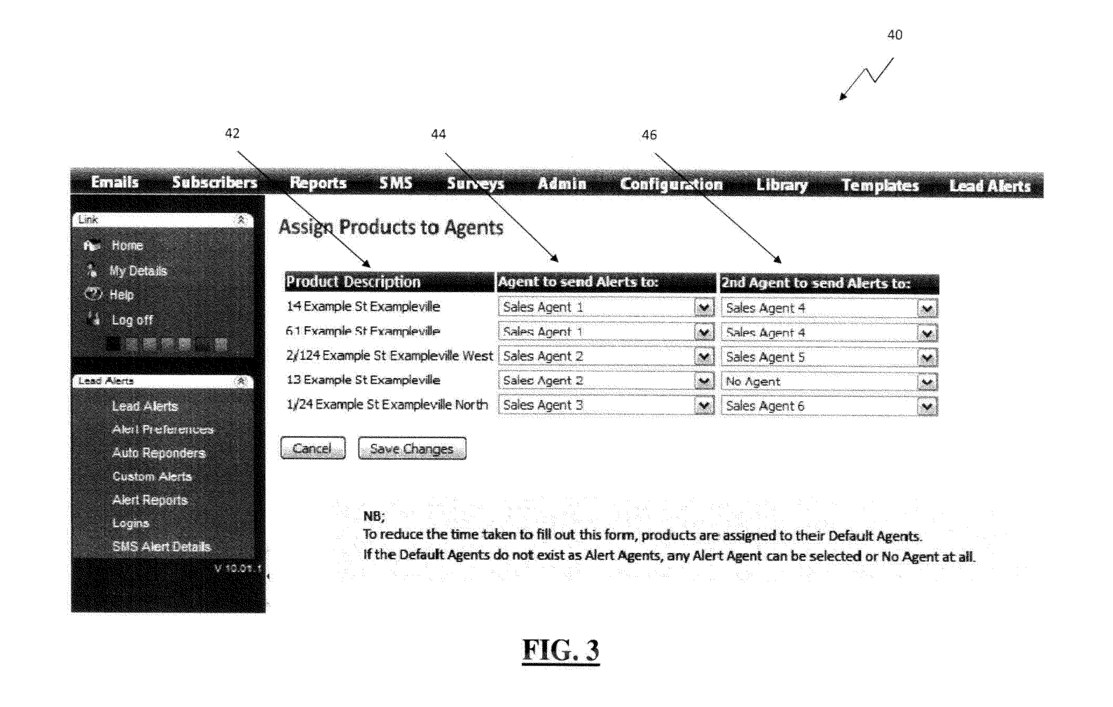

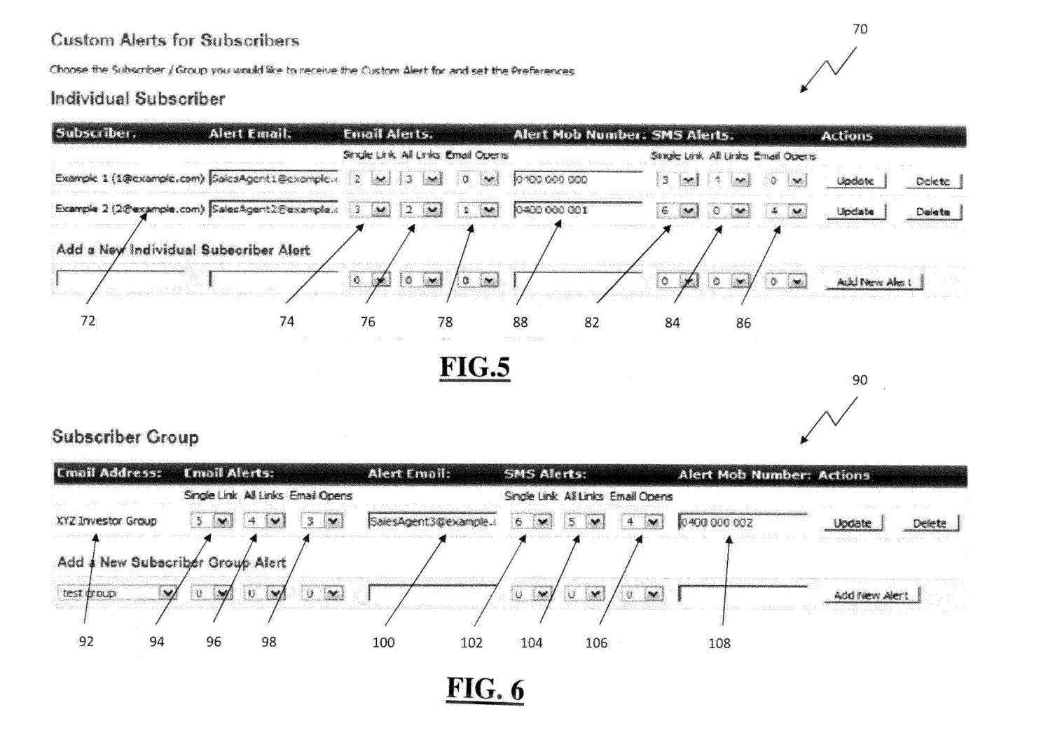

The broad method 30 will now be explained with reference to FIGS. 3 to 12 in which the method 30 is employed as part of a method for conducting an email marketing campaign for a real-estate agent having properties for sales.

In this specification, ‘sales person’ is used in broad sense and is meant to include a natural sales person or a legal sales person. For explaining the example below, a sales person includes a real estate agency, a sales representative, a sales administrator, and a sales manager.

With ‘information associated with the sales person’ is meant to include potentially any information associated with a sales person, however, in the embodiment described below ‘information associated with the sales person’ mainly includes information about commodities of the sales person. That is, information about a property that is for sale by the real estate agency.

In this embodiment, the candidate prospects are opt-in subscribers that have subscribed to a service of the real estate agency for receiving information about properties that are advertised for sale by the real estate agency. Therefore, information about the subscribers is known to the real estate agency and typically includes an email address, a name, and telephone number of the subscriber.

Prior to launching the email marketing campaign by sending emails to subscribers that include information about the properties that are for sale, the computer system 12 and the database 29 need to be configured.

The computer system 12 includes a plurality of user interface components that are pluggable from the computer system 12 to a terminal computer for rendering them into graphical user interfaces within a web page browser for permitting an authorized person (campaign administrator) to configure the computer system 12 for the email marketing campaign.

The computer system 12 is configured to include a plurality of properties that are for sale by the real estate agency and that are to be advertised during the email advertising campaign, and to include a list of subscribers to whom email messages are sent during the email marketing campaign.

At least one sales representative is specified in relation to each property that is for sale. FIG. 3 shows a rendered graphical user interface (GUI) 40 in which properties are listed, at 42, by way of their physical addresses, and it shows two dropdown boxes next to each property for selecting or entering the names of two sales agents, at 44 and 46. The names, email addresses, and mobile telephone numbers of the sales representatives are also stored on the database 29.

To this end, the computer system 12 is configured to include predefined activity criteria for each subscriber. The predefined activity criteria when met qualify the candidate prospect as a sales prospect, in response to which the sales representative is notified by sending of the notification message to the sales representative.

The activity criteria of each subscriber define activities that are detectable by the computer system 12 when it occurs at a terminal computer. Two types of activities that are detectable by the computer system 12 are the opening of an email message and the selection of hyperlinks at the terminal computer.

Using these two types of activities or events, three types of activity criteria can be preset for each subscriber. One type of activity criteria includes the number of times that an email is opened at terminal computers. Another type of activity criteria includes the number of times that a same hyperlink is selected (clicked) at a terminal computer 14, and a further type of activity criteria includes the number of times that any hyperlink are selected at the terminal computer.

There are several conventional ways in which these types of activities at the terminal computes are detectable by server computer systems. One way of detecting when an email is opened is to embed a unique hyperlink in the body of the email message, which unique hyperlink includes a subscriber ID that is associated with the subscriber's email address, and detecting when the unique hyperlink is activated when the email message is rendered for display on the terminal computer. This is also known as page tagging or web-bugging.

Similarly, one way of identifying when hyperlinks are selected presumably by a subscriber is to generate unique hyperlinks that include unique subscriber IDs that are associated with the subscribers respectively, and when the unique hyperlinks are activated or clicked then the subscriber ID is identified by the computer system 12. Instead, other techniques for web tracking such as session logging or cookies can be used for tracking subscriber online activities such as clicking of hyperlinks and opening of emails. Generally, techniques for detecting activities such as opening of an email or activating a hyperlink and recording the same (click-streaming) of a web user is well known in the art, and not described in detail herein.

The activity criteria for each user can be configured by an authorized person of the real estate sales agent, such as the campaign administrator. The preset activity criteria for the subscribers can be configured with the computer system 12 by way of one of three options.

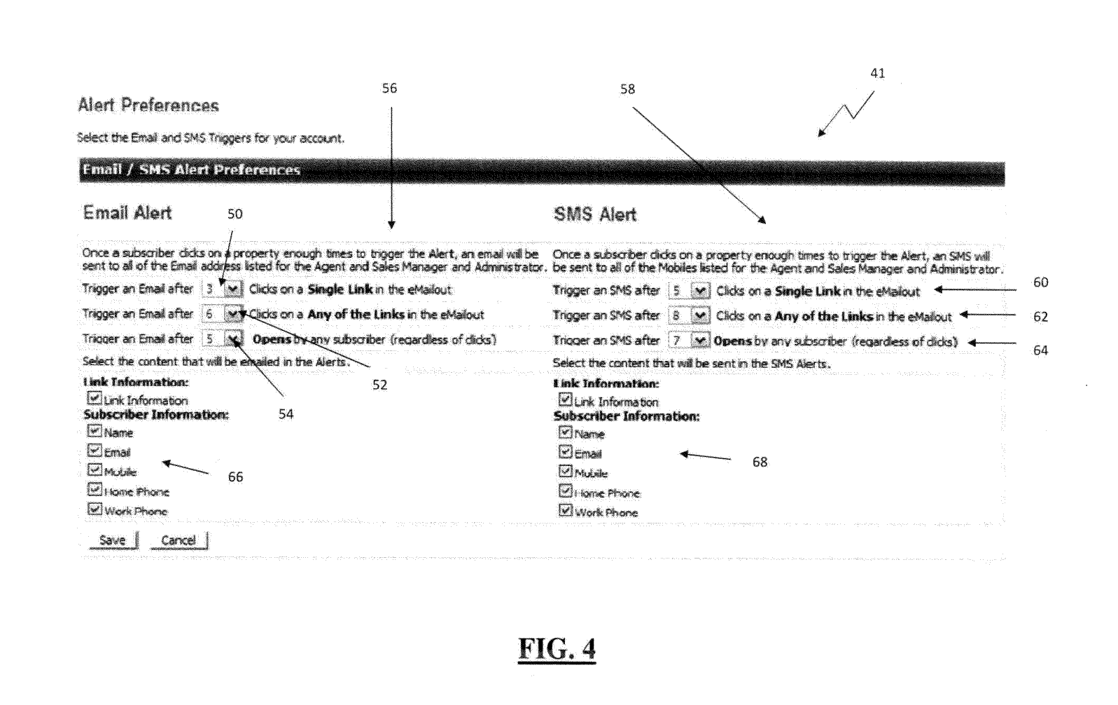

One option is to define the same activity criteria for all subscribers that partake in the email campaign of the real estate agency. Referring to FIG. 4 a user interface 41 is shown that is rendered on a terminal computer for permitting the campaign administrator to preset activity criteria that would apply to all the subscribers that partake in the email campaign. The user interface 41 include two sections, one section 56 is for setting activity criteria that when met triggers the sending of a notification message to the sales representative in the form of an email message. The other section 58 is for setting the activity criteria that when met triggers the sending of an SMS message to the sales representative.

The one section 56 includes input fields 50, 52, and 54 for setting the number of times that a same hyperlink is to be activated by a subscriber, the number of times that any number of hyperlinks is to be activated, by the subscriber and the number of times that an email message is to be opened by a subscriber to trigger the sending of the email message to the sales representative.

Similarly, section 58 includes input fields 60, 62, and 64 for setting the number of times that a same hyperlink is to be activated, the number of times that any hyperlink is to be activated, and the number of times that an email message is to be opened to trigger the sending of the SMS message to the sales representative.

In addition, user interface 41 also includes sections 66 and 68 for specifying the information that is included in the email message or the SMS message respectively. For example, section 66 includes tick boxes for selecting information about the relevant hyperlink to be included in the email message that is triggered, a name, email address, or telephone number of the subscriber that triggers the sending of the notification message.

FIG. 5 shows a user interface 70 for another option of setting activity criteria for a subscriber. This user interface permits the campaign administrator to preset unique activity criteria for an individual subscriber in relation to a specified sales representative.

The user interface 70 displays, at 72, the individually selected subscriber's email address, and includes input fields 74, 76, and 78 for setting the number of times that the same hyperlink is to be activated, the number of times that any number of hyperlinks is to be activated, and the number of times that an email message is to be opened to trigger the sending of an email message to the specified sales representative who's email address is input at 80.

Similarly, the user interface 70 includes input fields 82, 84, and 86 to preset the number of times that the same hyperlink is to be activated, the number of times that any number of hyperlinks is to be activated, and the number of times that an email message is to be opened to trigger the sending of an SMS message to the specified sales representative's mobile number that is input at 88.

Turning now to FIG. 5, a user interface 90 is shown for another option for defining activity criteria for subscribers. In particular, the user interface 90 is for defining activity criteria that apply to all subscribers in a predefined group of subscribers. The user interface 90 displays, at 92, the name of the group of subscribers, and includes input fields 94, 96, and 98 for setting the number of times that a same hyperlink is to be activated, the number of times that any number of hyperlinks is to be activated, and the number of times that an email message is to be opened by anyone of the subscribers in the group to trigger the sending of an email message to the specified sales representative's email address that is input at 100.

Similarly, the user interface 90 includes input fields 102, 104, and 106 for setting the number of times that a same hyperlink is to be activated, the number of times that any number of hyperlinks is to be activated, and the number of times that an email message is to be opened to trigger the sending of an SMS message to the specified sales representative who's mobile number is input at 108.

For ease of description hereinafter, the number of times that a same hyperlink is activated is referred to as same-link criteria, the number of times that any number of hyperlinks is activated is referred to as any-link criteria, and the number of times that an email message is opened is referred to as email-opened criteria.

Although activity criteria are set for the subscribers, there may be circumstances in which a sales representative, sales administrator, or sales manager, does not desire to receive a notification message when any particular one of the three criteria is met for a subscriber.

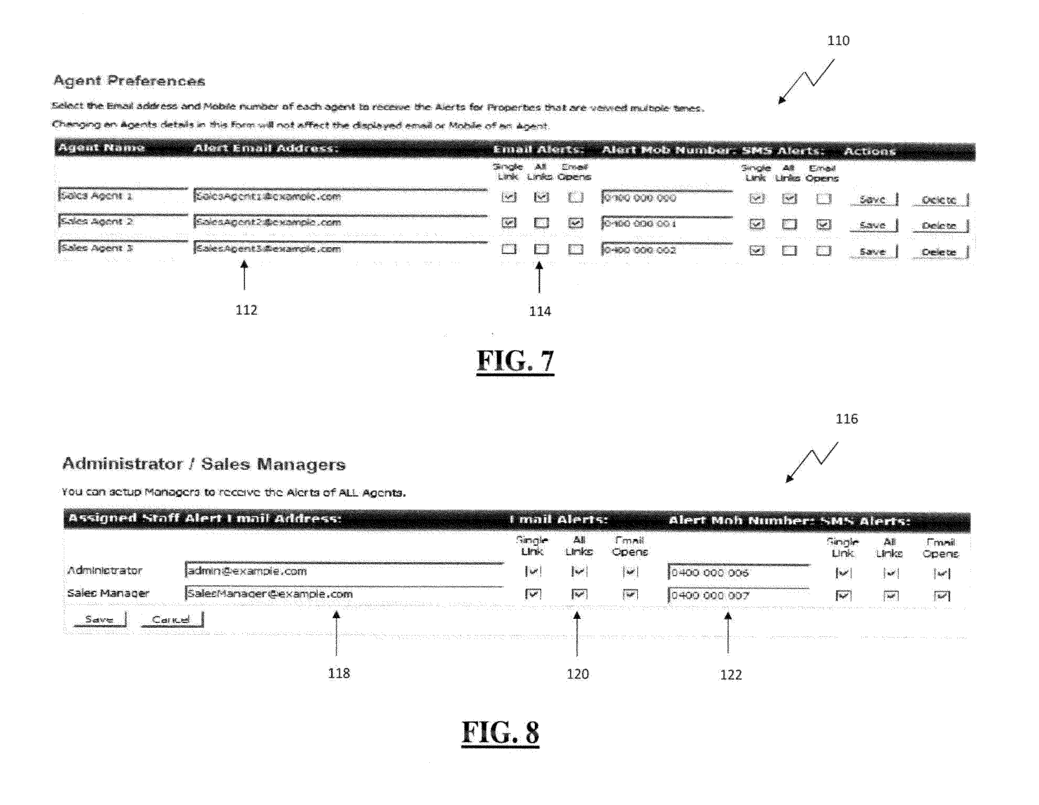

Therefore, the computer system 12 includes another user interface component 110 shown in FIG. 7 for permitting the authorized person to select the type of preset activity criteria in relation to which a sales representative, sales administrator, or sales manager, wishes to receive a notification message.

The user interface 110 includes the name of the sales representatives (sales administrator or sales manager) and their email addresses at 112. AT 114, adjacent to each sales representative's email address, are three check boxes associated with the three types of activity criteria respectively by way of which a sales representative can select or deselect the type of activity criteria in relation to which the sales representative wishes to receive a notification message.

Yet another user interface component 116 is shown in FIG. 8 in which email addresses, at 118, and mobile numbers, at 122, of sales administrators and sales managers are entered for receiving copies of notification messages that are sent to any one of the sales representatives. Similarly as to the above, the user interface 116 includes check boxes, at 120, for activating or deactivating the receiving of notification messages selectively in relation to any one of the types of activity criteria.

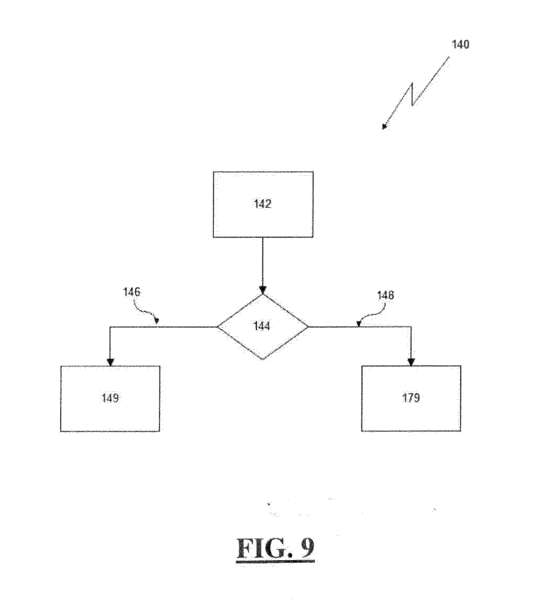

With reference to FIGS. 9 to 12 the method steps of method 30 of the computer system 12 will now be described in more detail in light of the configuration of the computer system 12 as described above.

The email marketing campaign is started by sending email messages to all the subscribers. The email messages include unique page tags that include a unique batch ID for the email marketing campaign and a unique subscriber ID for each subscriber. The email messages also include unique hyperlinks relating to each subscriber that link to web content about properties that are for sale by the real estate sales agent.

Referring to FIG. 9, at 142, a request from a unique hyperlink (either from a page tag in an email or from a hyperlink in an email or a hyperlink on a web page) is detected when activated at a terminal computer. At 144, the computer system 12 determines if the request is in response to an email that was opened, in which case leg 146 is followed, or in response to activation of a hyperlink that references web content of a property of the real estate agent that is for sale, in which case leg 148 is followed.

If the request is in response to an email that was opened, then a script is executed, at 149.

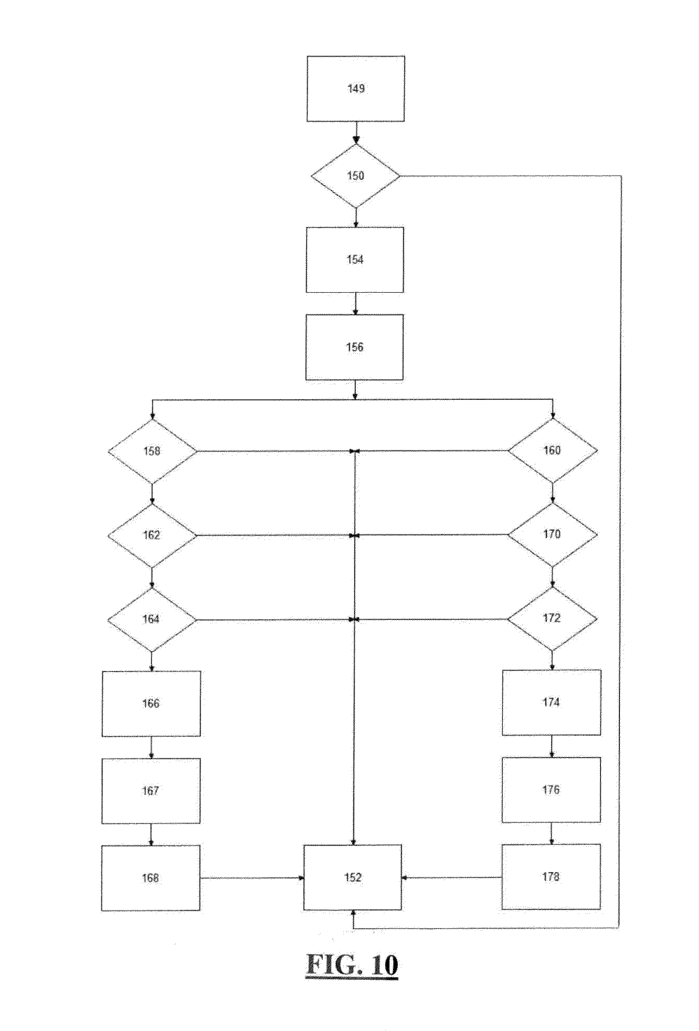

Following in FIG. 10, the computer system 12 authenticates, at 150, the email message. This is to determine if the email that was opened actually is part of the running email campaign that uses the notification messages sending feature of the computer system 12. This can be done by for example checking a batch ID in the unique request from the page tag and comparing it with a record of running or live batch ID associated with one of any active campaigns for various vendors or real-estate agents.

If the email is not authenticated, then the script terminates, at 152.

If the email is authentic, then the subscriber associated with the email that was opened is identified, at 154, and an email-opened event is logged, at 156, in the activity record of the subscriber.

At 158, a check is performed to determine if the open-email events that are recorded for the subscriber meets the open-email criteria that are preset for the subscriber for triggering a notification email message, and if not, then the script terminates at 152. If the logged open email events of the subscriber meet the preset open-email criteria, then a notification message-sent record is checked, at 162, to determine if a notification email message has already been sent to the sales representative. If a notification email message has not been sent, then the computer system 12 determines, at 164, if a notification email message is actually requested by any person (sales representatives, sale administrators, and sale managers). If the notification email message is actually requested, then the email message content is retrieved, at 166, from the database and the message is sent, at 167, to an email server for delivering the notification message to the persons that requested the notification email message. At 168, the notification message sent event is logged in the message-sent record in relation to the persons to whom it was sent. The script then terminates at 152.

Similarly, once the activity record for the subscriber is updated, at 156, by logging the open-email event then, at 160, a check is performed to determine if the number of logged open-email events matches the preset open email criteria for triggering a notification SMS message. If false, then the script terminates at 152. However, if true then the notification message-sent record is checked, at 170, to determine if a notification SMS message has already been sent to the sales representative. If a notification SMS message has not been sent, then the computer system 12 determines, at 172, if a notification SMS message is requested by any person (sales representatives, sale administrators, and sale managers). If the SMS message is actually requested, then the SMS message content is retrieved, at 174, from the database and the SMS message is sent, at 176, to an SMS server for delivering the notification SMS message to the persons that requested the notification SMS message. At 178, the message-sent record is updated that the notification SMS message was sent to the relevant persons.

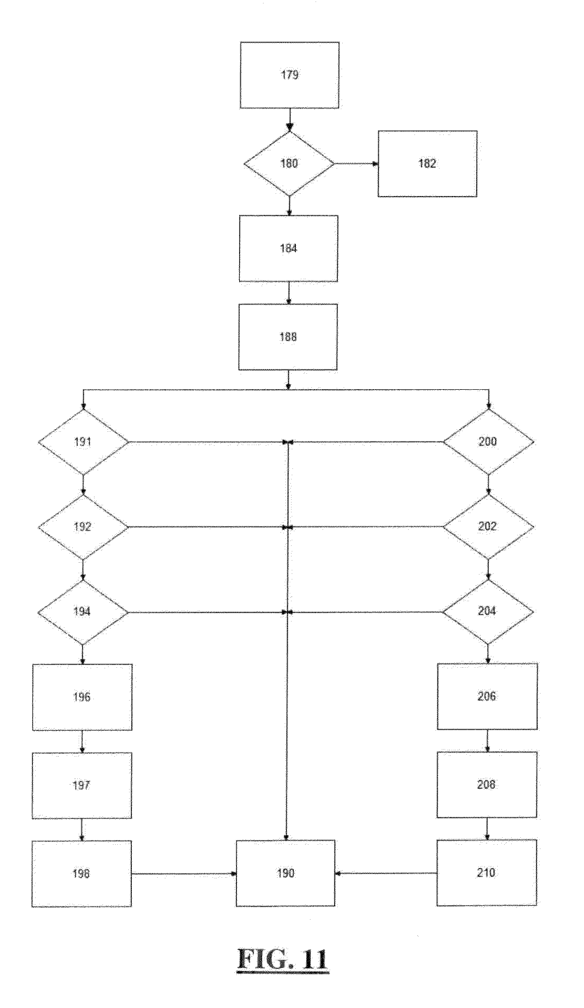

Turning now to FIG. 11 and if the computer system 12 determined, at 144, that the request is in response to activation of a unique hyperlink that references web content of a property of the real estate agent that is for sale, then at 179, a relevant script executes.

The computer system 12 authenticates, at 180, the hyperlink that was activated to determine if hyperlink are a valid hyperlink relating to the relevant running email campaign.

If the hyperlink is not valid, then the script exits at 182. If the hyperlink is authentic, then the subscriber associated with the activation of the hyperlink is identified, at 184. The computer system 12 then updates the activity profile record of the subscriber, at 188.

At 191, a check is performed to determine if the same-link events logged for the subscriber meets the preset same-link criteria for triggering a notification email message, and if false, then the method proceeds to the any-link script, at 190.

If the logged same-link events meet the same-link criteria then the notification message-sent record is checked, at 192, to determine if a notification email message has already been sent to the sales representative.

If a notification email message has not been sent, then the computer system 12 identifies, at 194, if a notification email message is actually requested by any person (sales representatives, sale administrators, and sales managers) and if the email message is actually requested, then the email message content is retrieved, at 196, from the database and the message is sent, at 197, to an email server for delivering the notification email message to the persons that requested the notification email message. At 198, the notification message-sent record is updated to show the notification email message is sent to the relevant persons, and the method proceeds to the any-link script, at 190.

Similarly, if the activity profile record of the subscriber is updated, at 188, by logging a same-link event for the subscriber, then, at 200, a check is performed to determine if the same-link criteria for the subscriber meet the same-link criteria for triggering a notification SMS message, and if false, the method proceeds to the any-link script, at 190.

However, if the logged same-link events for the subscriber meet the preset same-link criteria then the notification message-sent record is checked, at 202, to determine if a notification SMS message has already been sent to the sales representative. If a notification SMS message has not been sent, then the computer system 12 determines, at 204, if a notification SMS message is actually requested by any person (sales representatives, sale administrators, and sales managers). If the SMS message is actually requested, then the email message content is retrieved, at 206, from the database and the message is sent, at 208, to an SMS delivery server for delivering the notification SMS message to the persons that requested the notification SMS message. At 210, the notification message sent log is updated to show the notification SMS message is sent to the relevant persons, after which the method proceeds to the any-link script, at 190.

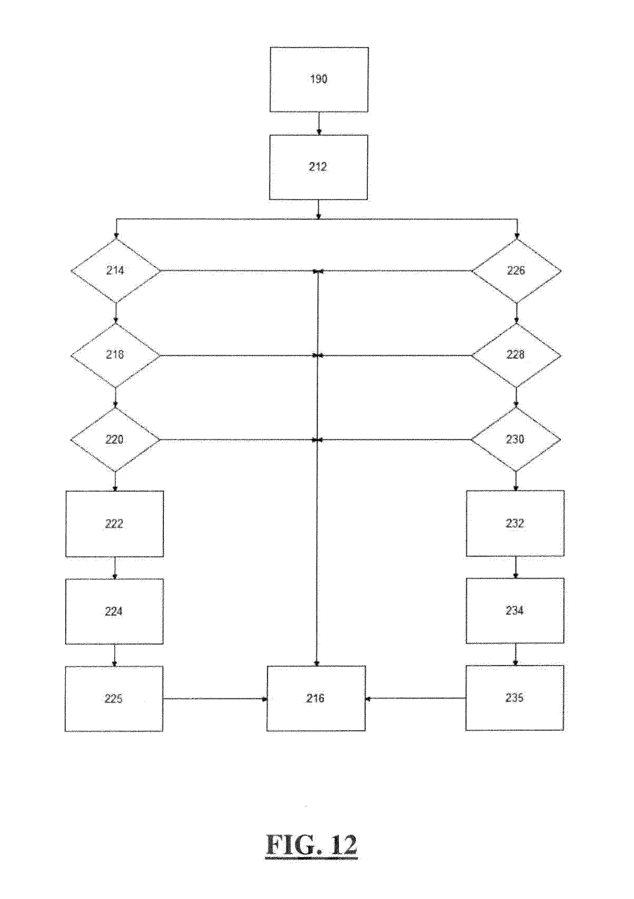

Referring to FIG. 12, when the method proceeds to the any-link script, at 190, the computer system 12 updates, at 212, the activity profile record by logging the any-link event in relation to the subscriber. A check is performed, at 214, to determine if the logged any link events for the subscriber meet the any-link criteria for the subscriber to trigger a notification email message, and if false, then the method exits, at 216

If the logged any-link events meet the preset any-link criteria then the notification message-sent record is checked, at 218, to determine if a notification email message has already been sent to the sales representative. If a notification email message has not been sent, then the computer system 12 determines, at 220, if a notification email message is actually requested by any person (sales representatives, sale administrators, and sales managers). If the email message is actually requested, then the email message content is retrieved, at 222, from the database and the message is sent, at 224, to an email server for delivering the notification email message to the persons that requested the notification email message. At 225, the notification message-sent record is updated to show the notification email message is sent to the relevant persons, and the method exits, at 216.

Similarly, if the activity profile record of the subscriber is updated, at 212, by logging an all-link event then, at 226, a check is performed to determine if the logged any-link events for the subscriber meets the preset any-link criteria for triggering a notification SMS message, and if false, the method exits, at 216.

However, if the logged any-link events meet the any-link criteria for the subscriber then the notification message-sent record is checked, at 228, to determine if a notification SMS message has already been sent to the sales representative. If a notification SMS message has not been sent, then the computer system 12 determines, at 230, if a notification SMS message is actually requested by any person (sales representatives, sale administrators, and sales managers). If the SMS message is actually requested, then the SMS message content is retrieved, at 232, from the database and the message is sent, at 234, to an SMS server for delivering the notification SMS message to the persons that requested the notification SMS message. At 235, the notification message-sent record is updated to show the notification SMS message is sent to the relevant persons, after which the script exits at 216.

The method further includes sending a first response message to the subscriber at the same time when the notification message is triggered for sending to the sales person. The first response message can also be either an SMS message that is sent to a mobile phone of the subscriber or an email message that is sent to the email address of the subscriber.

The event of sending the first response message is also logged in the message sent-event record so that a check can be performed by the computer system 12 prior to sending of the first response message to avoid resending of the message.

The content of the first response message includes thank you message for expressing interest in a property, such as the property that was associated with the hyperlink the subscriber activated and that was triggered the first response message. The content also includes privacy information or a link to privacy information, for example information for dealing with statutory requirements for distribution of electronic communications. The content also includes assurances or disclaimers, for example an assurance that the email excludes any invasive software or spyware.

The content also includes a name of the sales person and a disclosure that a notification message was sent to the sales person, including activities of the subscribed that caused sending of the first response message.

The content can also include a survey questionnaire, including questions asking if the subscriber is a first home buyer, looking for a new residence, looking for an investment property, whether or not the property viewed by the subscriber appealed to the subscriber, if the subscribed is actually interested in buying a property, if the subscriber are looking to sell their property, or the like.

A copy of the first response message that is sent to the subscriber is also sent to the sales person.

A reply message received from the subscriber to the first response message is then automatically forwarded to the sales person, and the same is logged in the message sent event record. The computer system 12 is configurable to permit back-and-forth auto responding and replying of messages between the subscriber and computer system 12 several times depending on, for example, the information that the sales person would like to obtain from the identified subscriber before pursuing the subscriber as an actual sales lead.

### Advantages

The advantages of the preferred embodiment of the computer system and method as described above is that a sales person is immediately notified with a notification message when the online behavior or usage criteria of a subscriber is met, so that the sales person may follow up on the sales lead before the subscriber loses interest in the commodity or buys elsewhere.

Another advantage of the preferred embodiment is that the activity criteria for each subscriber (or a group of subscribers) is able to be preset by the sales person, so as to selectively quantify degrees of activity that triggers the sending notification messages.

The preferred embodiment, advantageously, also keeps record of all the events, including triggers, and messages sent in relation to the subscribers and sales persons which provide valuable management information for evaluating the efficiency of online marketing campaigns.

The preferred embodiment also facilitates the fast and efficient distribution of relevant marketing and sales information to various persons of a sales entity, and therefore also facilitates efficient knowledge management within the sales entity.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

What is claimed is:

1. A method for detecting on a server-side computer system one or more activities occurring at a terminal computer, and generating at a user device a notification in response to the one or more activities, the method comprising:
the server-side computer system generating an electronic message, the electronic message generated to include a first unique identifier identifying the electronic message and one or more second unique identifiers each corresponding respectively to one or more pieces of information in the electronic message;
the terminal computer displaying the electronic message and thereby interacting with the first unique identifier;
the terminal computer accessing one of the one or more pieces of information in the electronic message and thereby interacting with a second unique identifier corresponding to the accessed piece of information;
the server-side computer system detecting the terminal computer's interactions with the first unique identifier and the second unique identifier, and updating a database to record the interactions; and
the server-side computer system sending to a first user device a first message when both a first criterion and a second criterion are satisfied, wherein the first criterion requires the database to record a first predetermined number of interactions by the terminal computer with the first unique identifier, and the second criterion requires the first criterion to be and further that the database record a second predetermined number of interactions by the terminal computer with the second unique identifier.

2. The method as claimed in claim 1, wherein the electronic message is an electronic mail message (email).

3. The method as claimed in claim 1, wherein the first unique identifier is a first unique hyperlink, the first unique hyperlink being accessed as a result of the terminal computer displaying the electronic message, and the server-side computer system detects an access of the first unique hyperlink by the terminal computer as an interaction of the terminal computer with the first unique identifier.

4. The method as claimed in claim 1, wherein the one or more second unique identifiers are second unique hyperlinks, the second unique hyperlinks being accessed when the pieces of information corresponding thereto are accessed by the terminal computer, and the server-side computer system detects an access of the second unique hyperlink by the terminal computer as an interaction of the terminal computer with the second unique identifier.

5. The method as claimed in claim 1, wherein the server-side computer system sends a second message to a second user device when the first criterion is satisfied but the second criterion is not yet satisfied, and the second user device generates a second notification upon receipt of the second message.

6. The method as claimed in claim 1, wherein the first message is an email message, and the first user device to which the first message is sent is a user device operated by a responsible person for the piece of information accessed by the terminal device.

7. The method as claimed in claim 1, wherein the first message is a text message, and the first user device to which the first message is sent is a user device operated by a responsible person for the piece of information accessed by the terminal device.

8. The method as claimed in claim 5, wherein the second message is an email message, and the second user device to which the second message is sent is a user device operated by a person responsible for all the one or more pieces of information in the electronic message.

9. The method as claimed in claim 5, wherein the second message is a text message, and the second user device to which the second message is sent is a user device operated by a person responsible for all the one or more pieces of information in the electronic message.

10. The method as claimed in claim 8, wherein the first user device and the second user device are the same device.

11. The method as claimed in claim 9, wherein the first user device and the second user device are the same device.

12. The method as claimed in claim 1, wherein:
the one or more pieces of information is information corresponding respectively to one or more properties for sale;
the first user device is an electronic device operated by a sales agent responsible for the one or more properties for sale; and
the first message is an electronic mail message (email) configured to notify the sales agent that the recipient of the electronic message is a sales prospect who may have interest in the property corresponding to the piece of information accessed by the terminal computer.
